(19) United States
(12) Patent Application Publication
(10) Pub. No.: US 2005/0236515 A1
(43) Pub. Date: Oct. 27, 2005

(54) Internal link for aircraft

(76) Inventor: Anders Eneroth, Linghem (SE)

Correspondence Address: JACOBSON HOLMAN PLLC, 400 SEVENTH STREET N.W., SUITE 600, WASHINGTON, DC, 20004, US

(21) Appl. No.: 10/517,304

(22) PCT Filed: Jun. 18, 2003
(86) PCT No.: PCT/SE03/01042

§ 371 Date: Dec. 9, 2004

(30) Foreign Application Priority Data
Jun. 19, 2002 (SE) 0201873-7

(51) Int. Cl. G01S 7/36

(52) U.S. Cl. 244/6; 244/119; 244/129.1

(57) ABSTRACT

The present invention relates to an internal link for aircraft having at least a first pylon which is intended for a load and provided with signal cabling, intended for e.g. countermeasure pods, and power supply, and at least a second pylon which is intended for a load and provided with power supply, but which has no corresponding signal cabling. Signals to the load of the second pylon are sent via the signal cabling to first signal conversion equipment in connection with the first pylon and are sent through an antenna to second signal conversion equipment in connection with the second pylon where it is converted into the signal that existed in the signal cabling.

The present invention relates to an internal link for aircraft. A fighter aircraft usually has a plurality of pylons for external loads, such as weapons and countermeasure pods. As a rule, only one pylon of an aircraft is prepared to carry a countermeasure pod, which frequently requires RF cabling and control signals. In some cases, it is desirable to be able to carry a larger number of countermeasure pods. For instance, in international operations there is in many cases a need for an interference aircraft having extensive interfering resources.

Installing new RF cabling in the aircraft is not an easy operation. It involves such a complicated and comprehensive reconstruction that it can be done only in connection with a major reconstruction of the aircraft, which may occur only once in its life.

The present invention solves the problem so that at least one further load requiring control signals can be used without necessitating a complicated complete reconstruction. This takes place by the invention having the features that are evident from the independent claim. The remaining claims define suitable embodiments of the invention.

The invention will now be described in more detail with reference to the accompanying drawing, in which

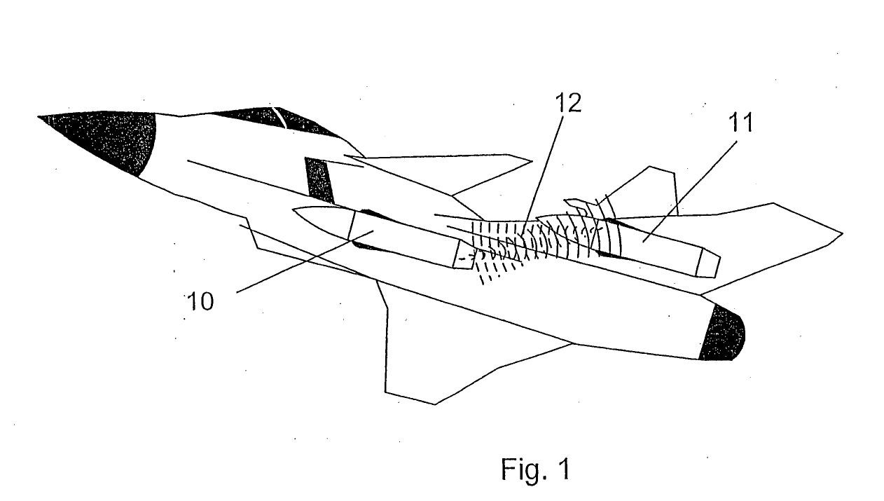

FIG. 1 shows two pods suspended from beams with communication between them according to the invention, and

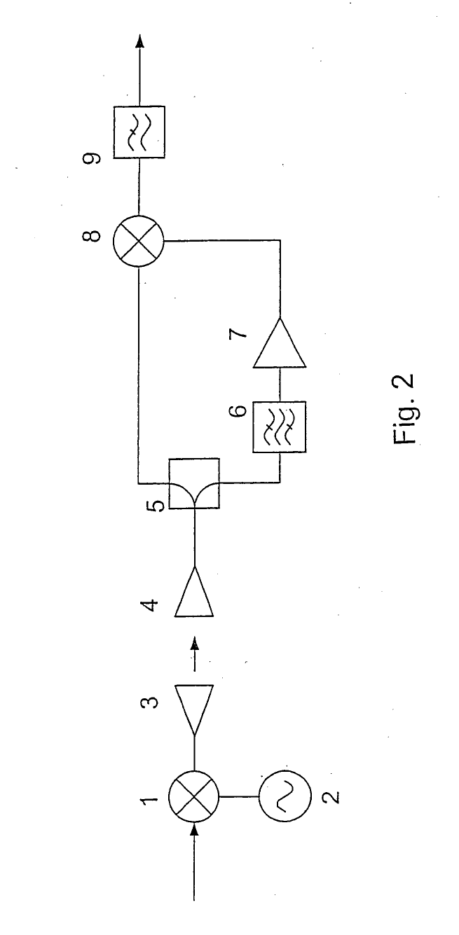

FIG. 2 shows an embodiment of how a signal can be transmitted from one pylon to another.

FIG. 1 shows how two loads 10, 11, such as countermeasure pods, are each suspended from a load beam of an aircraft. Both pylons are provided with power supply. However, only one of the pylons can receive control signals via cabling. Control signals to the other pod are converted by first signal conversion equipment adjacent to the first beam into electromagnetic signals 12 which are sent through an antenna to the second beam. Second signal conversion equipment of the same type as the first is arranged adjacent to the second beam. The signal is received through an antenna and converted into a control signal of a normal type for the second load.

Signals can also be sent in the other direction from the second load to the cabling adjacent to the first pylon.

The signal conversion equipment can be arranged in different ways adjacent to the respective pylons. They can either be attached separately to the beam, or the load can be modified so that the signal conversion equipment is part of the same while at the same time the load retains its capability to perform its task, for instance interference.

A diagram showing how a signal can be converted from the moment of leaving the cabling until it is regenerated in the second signal conversion equipment is to be found in FIG. 2. The signal to be transferred is supplied to a mixer 1 which is connected to a local oscillator 2. An antenna 3 is connected to the third port of the mixer 1. The signal sent by the antenna 3 is received by an antenna 4 which is of the same type as the antenna 3. The received signal is divided in a power divider 5. One branch is used to regenerate the local oscillator signal via a band-pass filter 6 which has a bandwidth which lets the LO signal pass, but blocks the mixed signal. The regenerated LO signal is amplified in an amplifier 7 and is then fed to the mixer 8. In the mixer, the regenerated LO signal is mixed with the transferred signal from the second port of the power divider. The signal from the mixer is filtered in a low-pass filter 9, and the original signal is regenerated.

It is, of course, important for the signals that are exchanged between the antennas 3, 4 not to be intercepted by the opponent's interception receiver. Their frequency should therefore be selected to allow them to be rapidly attenuated in air; a typical value can be an attenuation by at least 1 dB/km.

It is known that the atmosphere contains different frequency bands with different propagation attenuations. Among frequency bands with good transmission (low attenuation), mention can be made of the various radar bands (L,S,C,X,Ku), certain parts of the mm waveband (26-200 GHz), as well as IR bands.

A special frequency band around 60 GHz is of interest for opposite reasons. Attenuation is particularly high for this band and allows only short communication distances between transmitter and receiver at this frequency. The millimetre waveband above 58 GHz is of interest for use of links that are difficult to detect, but there are not very many components on the market. This means that the few components that are available are usually very expensive. Also higher frequencies are of interest, since monitoring systems operating at these high frequencies are most unusual.

A further advantage of the millimetre waveband is that the transmitted bandwidth is great in absolute bandwidth, but small as relative bandwidth. An example: at the X band, 1 GHz may be suitable to transmit. This is equivalent to about 10% in relative bandwidth, whereas at the 77 GHz band it is equivalent to 1.3%. The limited relative bandwidth implies, inter alia, that a system may be fairly flat in frequency response etc.

The band around 77 GHz is also special since it is used for car radar and therefore hardware is becoming available at competitive prices. In a particularly advantageous embodiment of the invention, a signal of the frequency 77±5 GHz is therefore used.

1. An internal link for aircraft having at least a first pylon which is intended for a load and provided with signal cabling, intended for e.g. countermeasure pods, and power supply, and at least a second pylon which is intended for a load and provided with power supply but which has no corresponding signal cabling, characterised by first signal conversion equipment in connection with the first pylon, said signal conversion equipment being connected to said signal cabling and converting signals therefrom into electromagnetic signals (12) intended to be sent through an antenna (3, 4) to the surroundings and vice versa, said electromagnetic signals having a frequency causing the signals to be rapidly attenuated in air, further characterised by an antenna (3, 4) for narrow beam transmission of the electromagnetic signals to and reception thereof from said second pylon and second signal conversion equipment in connection with the second pylon of a type equivalent to the first signal conversion equipment, whereby the second signal conversion equipment on an output has the same signal as the cabling adjacent to the first pylon, thus making it possible to use also the second pylon for loads requiring signal cabling.

2. An internal link for aircraft as claimed in claim 1, characterised in that the first signal conversion equipment is incorporated in the load which simultaneously is adapted to perform a main task, for instance as countermeasure pod.

3. An internal link for aircraft as claimed in claim 1, characterised in that the signal frequency in air is higher than 58 GHz.

4. An internal link for aircraft as claimed in claim 3, characterised in that the signal frequency in air is 77 GHz±5 GHz.

5. An internal link for aircraft as claimed in claim 2, characterised in that the signal frequency in air is higher than 58 GHz.
